(19) United States
(12) Patent Application Publication
(10) Pub. No.: US 2023/0185833 A1
(43) Pub. Date: Jun. 15, 2023

(54) System and Method for Organizing and Indexing Citations for Research Papers

(71) Applicant: Kristin Dugger, Syracuse, NY (US)

(72) Inventor: Kristin Dugger, Syracuse, NY (US)

(21) Appl. No.: 18/063,724

(22) Filed: Dec. 9, 2022

Related U.S. Application Data
(60) Provisional application No. 63/287,568, filed on Dec. 9, 2021.

(51) Int. Cl. G06F 16/31

(52) U.S. Cl. CPC G06F 16/313

(57) ABSTRACT

The present invention relates to a reference organizing and indexing system for research papers. The system can be used by students, universities, researchers, and companies for saving time to correctly include citations and references in their research papers. The system offers a software application that is configured to identify the source and metadata including author, page numbers, and dates of references to be used as citations. The system eliminates the need of a researcher to manually search and collect the citation information. A plurality of citations is indexed which can then be retrieved in a proper format for inclusion in research papers. The citations can be added as footnotes, bibliographies, and/or in-text citations.

### CROSS-REFERENCE TO RELATED APPLICATION

The present application claims priority to, and the benefit of, U.S. Provisional Application No. 63/287,568, which was filed on Dec. 9, 2021 and is incorporated herein by reference in its entirety.

### FIELD OF THE INVENTION

The present invention relates generally to the field of research papers. More specifically, the present invention relates to a novel system for organizing references for a research paper in an index. The system offers an application wherein users can highlight quotes and ideas (text) and drop them into a document where the system identifies the source of the text, collects the highlighted portions, and automatically includes the source, author, page number, and dates of the reference. The system eliminates manually adding citations in research papers. Accordingly, the present disclosure makes specific reference thereto. Nonetheless, it is to be appreciated that aspects of the present invention are also equally applicable to other like applications, devices, and methods of manufacture.

### BACKGROUND

By way of background, citations are one of the most important aspects of research paper writing. Citing sources helps readers distinguish researcher's ideas from those of their sources and gives proper credit to the authors of the words or ideas which are incorporated into the research paper. Citations can be included at various places in a research paper such as in footnotes, bibliography, and in the body of the text itself.

Commonly researchers manually add citations to their research papers. Manually adding citations and references is challenging, time consuming, and frustrating. Adding citations takes time and generally, students, researchers and more run out of time. Different disciplines require citations in different styles; therefore, a person needs to learn about different styles of citations which is frustrating. People often end up adding citations in an incorrect format which may lead to rejection of their research paper. Identifying and adding important information such as date, author, and page numbers are difficult to identify and constantly takes attention away from the paper's content. Maintaining multiple citations is difficult and researchers miss important citations and references.

Therefore, there exists a long-felt need in the art for a system that easily and correctly creates citations for research papers. There is also a long-felt need in the art for a system that pulls all necessary information from the source of a citation. Additionally, there is a long-felt need in the art for a citation organizing system that can provide an easy-to-use software application for logging and organizing of references. Moreover, there is a long-felt need in the art for a specialized system that eliminates the need to manually insert details of citations while writing a research paper. Further, there is a long-felt need in the art for citation application that easily creates footnotes, bibliographies, and in-text citations for a research paper. Furthermore, there is a long-felt need in the art for a system that can incorporate different formatting of citations. Finally, there is a long-felt need in the art for an application or software that eliminates the need to manually search and insert sources in a research paper, saving extensive time and effort of a researcher.

The subject matter disclosed and claimed herein, in one embodiment thereof, comprises a computer-implemented, machine-readable system for automatically indexing and organizing citations or references for a research paper. The system comprises a document search module for identifying a source of a document from which a reference text used as a citation is selected by a researcher, an XML convertor for converting the document to XML format for parsing the content and metadata of the document, a text extractor for extracting reference text from the XML format, a metadata extractor for extracting metadata including author, page number, and dates of the document from the XML format, a reference creator module for creating an indexed citation including reference text and metadata, a holding page creator for creating a holding page to include indexed citations and a reference retriever module for retrieving one or more indexed citation from the holding page as one or more of a footnote, a bibliography, an in-text reference, or an in-text citation.

In this manner, the research paper citations/references organizing and indexing system and associated method of the present invention accomplish all of the foregoing objectives and provides users with a software application designed to log and organize references in an index when writing a research paper. The application enables users to easily create footnotes, bibliographies, and in-text citations when writing a research paper. The system automatically includes page numbers and other important information for the reference and organizes it in a numbered list for easy access.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer-implemented method for organizing research paper references in an index. The method comprises the steps under control of one or more computing systems configured with specific executable instructions, receiving text in a reference document, the text is to be used as a citation in a research paper; identifying a source of a document which contains the text and from which the text is received by the reference document; identifying metadata of the document, the metadata including at least an author, a page number, and dates of the document; indexing text and metadata as a citation in a holding document; retrieving citation as one of a footnote, bibliography, in-text reference or in-text citation for the research paper and placing the retrieved citation in the research paper.

In yet another embodiment, the computer implemented method includes the steps of receiving a preference of using the citation as one of footnote, bibliography, in-text reference, or in-text citation and removing a citation already included in the research paper.

In yet another embodiment, a system for automatically indexing and organizing citations or references for a research paper is disclosed. The system comprises a document search module for identifying a source of a document from which a reference text is selected by a researcher, an XML convertor for converting the document to XML format for parsing the content and metadata of the document, a text extractor for extracting reference text, a metadata extractor for extracting metadata including author, page number, and dates of the document, a reference creator module for creating a citation including reference text and metadata, a holding page creator for creating a holding page to include indexed citations and a reference retriever module for retrieving one or more indexed citations from the holding page as one or more of footnote, bibliography, in-text reference, or in-text citation.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a flow diagram of an exemplary process for logging and organizing references for a research paper in accordance with the disclosed architecture;

FIG. 2 illustrates a functional block diagram of the module system for logging and organizing references for a research paper in accordance with the disclosed architecture;

FIG. 3 illustrates a schematic view of another embodiment of the citations organizing and indexing system of the present invention in accordance with the disclosed architecture;

FIG. 4 illustrates a flow diagram depicting a process of placing an indexed citation in a research paper by a user in accordance with the disclosed architecture;

FIG. 5 illustrates an exemplary user interface for providing different options of using the software application of the present invention in accordance with the disclosed architecture;

FIG. 6 illustrates another exemplary user interface offered by the application of the present invention for removing citations from a research paper in accordance with the disclosed architecture; and

FIG. 7 illustrates an exemplary computing device that is used for installing the software application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a system that easily and correctly creates citations for research papers. There is also a long-felt need in the art for a system that pulls all necessary information from the source of a citation. Additionally, there is a long-felt need in the art for a citation organizing system that can provide an easy-to-use software application for easy logging and organizing of references. Moreover, there is a long-felt need in the art for a specialized system that eliminates the need to manually insert details of citations while writing a research paper. Further, there is a long-felt need in the art for citation application that easily creates footnotes, bibliographies, and in-text citations for a research paper. Furthermore, there is a long-felt need in the art for a system that can incorporate different formatting of citations. Finally, there is a long-felt need in the art for an application or software that eliminates the need to manually search and insert sources in a research paper, saving extensive time and effort of a researcher.

The present invention, in one exemplary embodiment, is a computer-implemented method for organizing a research paper references in an indexed manner for easy access. The method comprises the steps of receiving a citation text in a reference document, the text is to be used as a citation in a research paper; identifying a source of a document which contains the text and from which the text is received by the reference document; identifying metadata of the document, the metadata including at least an author, a page number, and dates of the document; indexing text and metadata as a citation in a holding document; retrieving citation as one of a footnote, a bibliography, an in-text reference or an in-text citation for the research paper and placing the retrieved citation in the research paper.

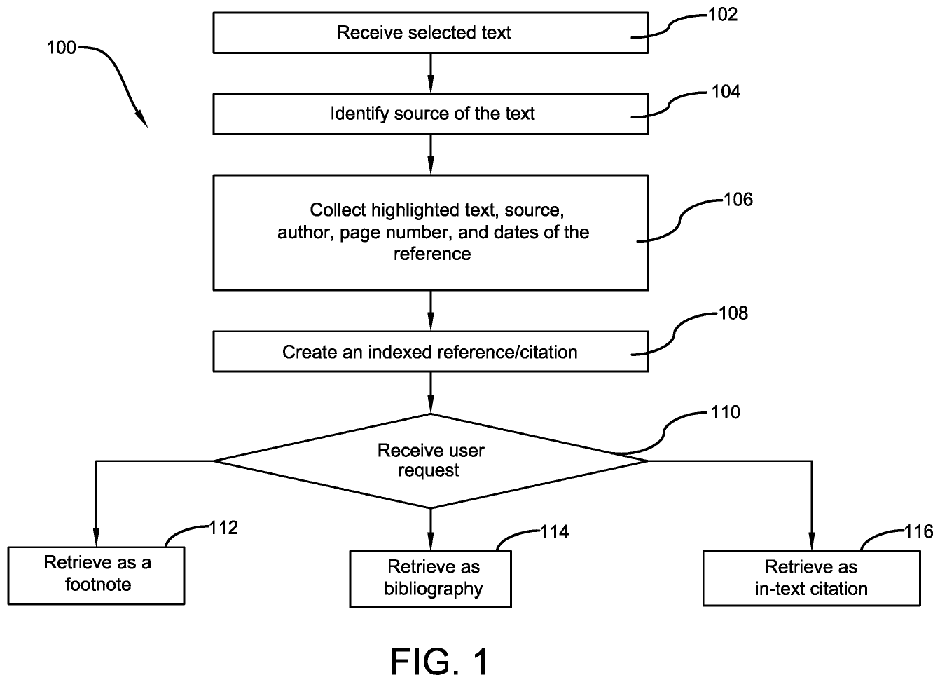

Referring initially to the drawings, FIG. 1 illustrates a flow diagram of an exemplary process for logging and organizing references for a research paper in accordance with the disclosed architecture. The exemplary process 100 is shown in multiple blocks as described and is performed by the computer implemented citation software application system 200 of the present invention. At block 102, a text selected by a user is received in a reference document. The text can be selected from any document and can be a few words, a few sentences, one or more paragraphs, quotes, ideas, and more and may be relevant to a user for future research and/or research paper. The documents from which the text is selected can be of any kind of document. Any type of HTM/PDF document such as web documents (such as Web pages, PDF files, image files, and other documents accessible through the Internet) can be used for selecting the text. In some embodiments, the documents may be placed in a computer system, such as a server having a storage device. The text is received in a reference page which is a specialized page for receiving the desired text.

At block 104, the source or URL of the text is extracted. This step may include parsing of documents or references to identify the relevant text and extraction of URL. It may be a single step process and can be automatically performed upon receiving the text or can alternatively be manually performed by a user. The URL once identified, is associated with the text. It is noted that the URL is not limited to any format and may be accessible using different protocols (such as http, https, ftp, and more). In situations where multiple sources are identified for the text, the most relevant and open-source source is considered as per the preferred embodiment of the present invention.

At block 106, the highlighted text, source, and metadata such as author, page number, and dates of the reference are collected. The information of the reference is parsed to identify metadata and an appropriate format of the metadata is formed. At block 108, an indexed reference number is created that incorporates the reference in a citation form and is stored in a separate document referred to as a holding document and is described later in the disclosure. The references in the holding document are related to a pseudo-link wherein the pseudo-link may be similar to the HTML type links that are explicit, clickable, and include a predetermined standard format, but can take any form as long as it is operational to retrieve the stored information of the reference.

Once the reference is created and indexed, then at block 110, while writing a research paper, if the user wants to use one of the references (such as quotes or ideas), then a request is received from the user and the reference can be used as a footnote, bibliography, or in-text citation. Based on the choice of the user, at block 112, the reference is retrieved as a footnote and applied accordingly to the research paper. At block 114, the reference is retrieved as a bibliography, and at block 116, the reference can be retrieved as an in-text citation and applied/used accordingly.

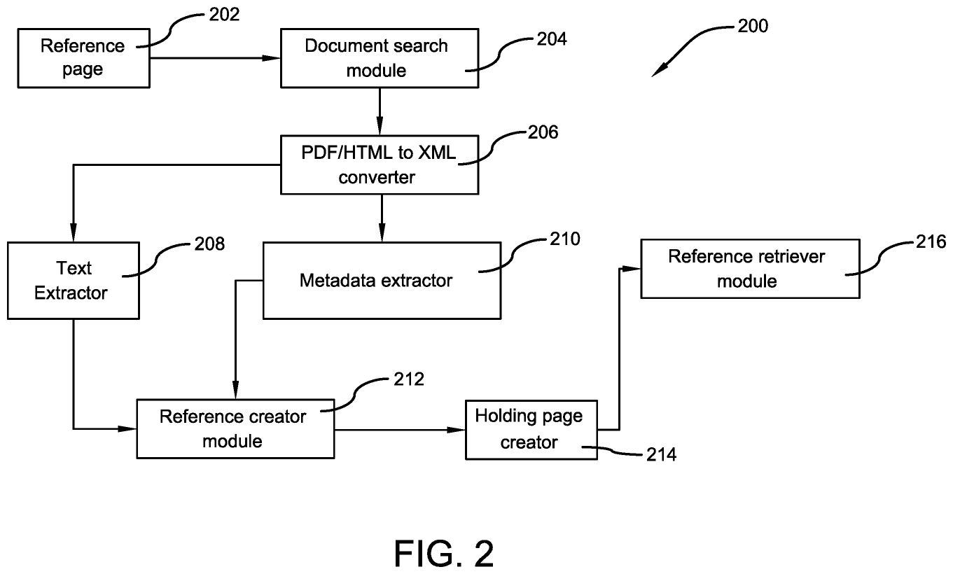

FIG. 2 illustrates a functional block diagram of the module system 200 for logging and organizing references for a research paper in accordance with the disclosed architecture. A reference page 202 is a specialized document configured to receive text from a user. The reference page 202 can include consecutive portions enabling a user to include references of different documents. A user may create a plurality of reference pages 202 as per the requirements. A document search module 204 is configured to search for a source (such as URL) of the text included in the reference page 202. The search module 204 may be automatically activated during the time when text is included in the reference page 202 or can be manually activated by the user using a control, such as an icon offered by the system 200. It should be appreciated that the system 200 may function in the form of a computer implemented software that provides a plurality of user interfaces for enabling users to index and organize references.

A reference document containing the text of a reference page 202 identified by the module 204 is converted into Extensible Markup Language (XML) format by PDF/HTML to XML converter 206. The conversion to XML format extracts the text elements and the metadata information from the reference documents. Any type of unstructured or structured document can be converted to XML format. Any original format such as Hypertext Markup Language (HTML), Portable Document Format (PDF), PostScript (PS) format, and more can be converted into XML format by the converter module 206.

From the XML format, a text extractor module 208 extracts the relevant textual portion that is originally included in the reference document. The text extractor 208 scans the text of the XML format of the document to identify the relevant text and retrieves the desired text. A metadata extractor 210 retrieves the desired metadata information such as author, page number, and dates of the reference from the XML format. The metadata extractor 210 may automatically create logical page numbers in situations where page numbers are not printed on a reference document converted into XML format.

The text from module 208 and the metadata from the metadata extractor 210 are passed onto a reference creator module 212 which is configured to produce an indexed reference for use by a user with an index linked with the reference. The reference created by module 212 for a reference document contains the relevant text and metadata extracted as described above. The indexed reference is stored in a holding page as a citation and the holding page is created by a holding page creator 214. The holding page creator 214 creates a unique indexed holding document that has the indexed references included therein. A user may select one or more holding documents for storing the indexed references as a citation per their preferences.

For using a citation from a holding page as a footnote, a bibliography, an in-text citation or text, the citation or indexed reference can be selected by a user and the reference retriever module 216 is configured to retrieve the selected citation in an appropriate format to include in a research paper of the user.

It should be noted that various modules or blocks described in the present embodiment are software modules having machine readable instructions that are executed by a processor of a computing device using the system 200. In some embodiments of the present invention, a server such as an application server may perform some of the functionality such as document search to identify the source of a reference document.

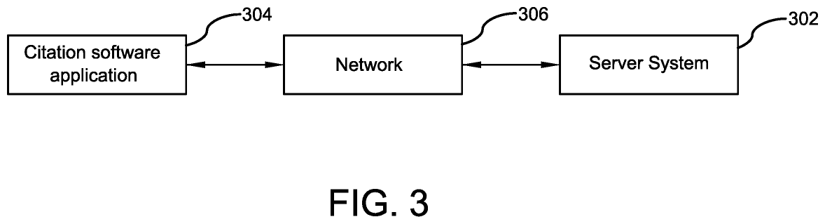

FIG. 3 illustrates a schematic view of another embodiment of the citation organizing and indexing system of the present invention in accordance with the disclosed architecture. In the present embodiment, a server 302 such as an application server, distributed server or cloud server is connected to the software application 304 via a network 306 such as internet. The application 304 is configured to provide user interfaces for enabling a user to index references for use as citations in research papers. The server 302 in the present embodiment is configured to identify the source, collect the highlighted portions, and automatically include the source, author, page number, and dates of the references for reducing the processing of the application 304. Further, the holding page as described in FIG. 2 is stored in an internal memory (not shown) of the server 302 for future use. In some embodiments, one or more holding pages can be downloaded from the server 302 to the application 302 for enabling use by a user.

The network 306 may include any wireless or wired channel associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

The server 302 is configured to have the logic, instructions, circuitry, interfaces, and/or codes for executing various operations required for communication between the server 302 and the application 304. Further, the server 302 may include, but are not limited to, personal computers, laptops, mini-computers, mainframe computers, any non-transient and tangible machine that can execute a machine-readable code, cloud-based servers, distributed server networks, or a network of computer systems.

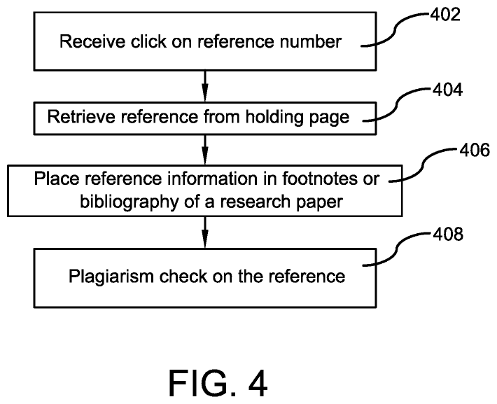

FIG. 4 illustrates a flow diagram depicting a process of placing an indexed citation in a research paper by a user in accordance with the disclosed architecture. Initially, at block 402, a reference number in a holding document is clicked or selected by a user for inserting into a research paper. At block 404, the reference retriever module, retrieves the reference in an appropriate format from the holding page.

Based on the preference of the user, at block 406, the reference or citation information (including text and metadata) are placed in a footnote, a bibliography, or an in-text of the research paper. Finally at block 408, the system also checks for any plagiarism in the research paper from the citations and alerts the user.

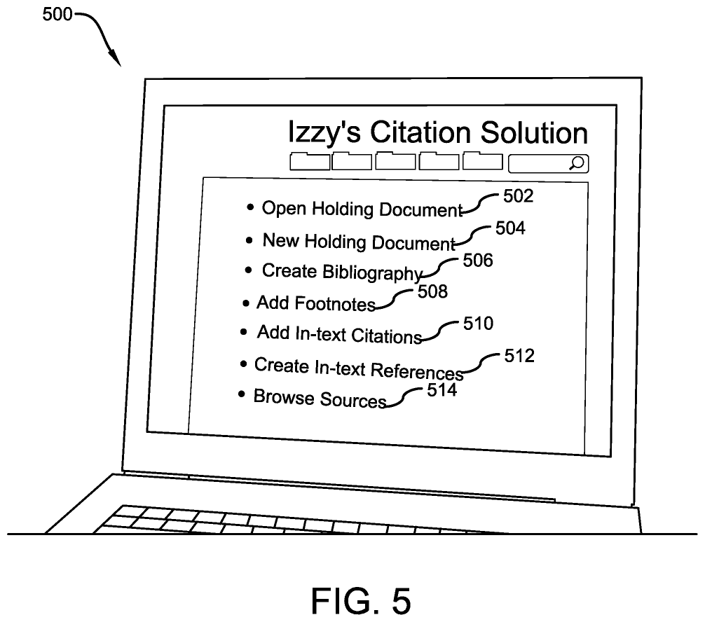

FIG. 5 illustrates an exemplary user interface 500 for providing different options of using the software application of the present invention in accordance with the disclosed architecture. “Open holding document” option 502 enables a user to select and open an existing holding document containing indexed references stored by the user. The holding documents have unique names and may be provided in role-based access in an organization, college, university and more. “New holding document” option 504 enables users to make a new holding document for adding new references citations. The new holding document can be used specifically for a new research paper.

Before writing a new research paper, an option for adding citations as bibliography can be chosen by a user. The “Create bibliography” option 506 configures the selected references from a holding document to be added as bibliography in a research paper in an appropriate format without any plagiarism.

Similarly, the “Add footnotes” option 508 when selected, enables the addition of citations as footnotes below a research paper, “Add in-text citations” option 510 enables the addition of selected citations as in-text citations and the “Create in-text references” option 512 add the text of the references without plagiarism in the research paper. All the sources stored on a server or indexed in the system can be browsed for selection using the “Browse sources” option 514. In some embodiments of the present invention, a user can browse the internet using a search bar provided by the “Browse sources” option 514.

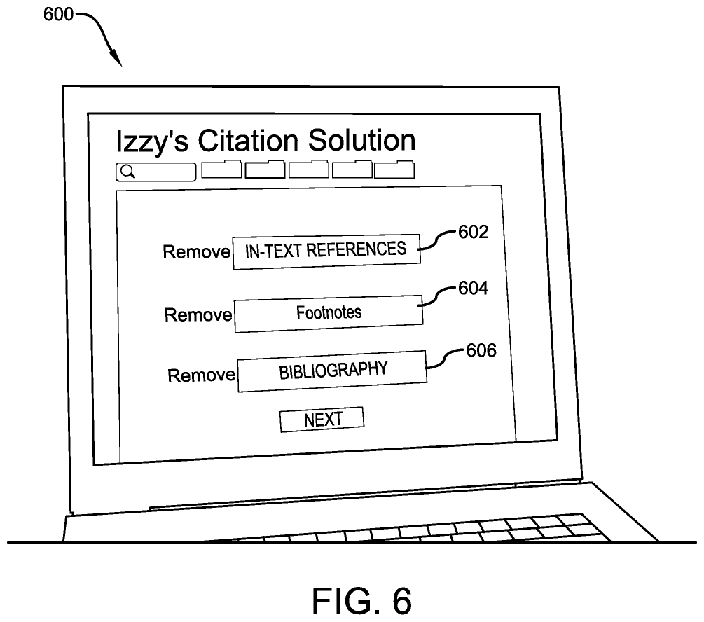

FIG. 6 illustrates another exemplary user interface offered by the application of the present invention for removing citations from a research paper in accordance with the disclosed architecture. A research paper that a researcher wants to write is opened in the application 304 enabling the user/researcher to access the holding pages for inserting citations directly into the research paper. Further, the application 304 also enables a researcher to easily remove the citations from research papers in a single click without manually erasing or deleting the citations.

The user interface 600 provides the options “remove in-text references” 602, “remove footnotes” 604 and “remove bibliography” 606 for removing citations from in-text, footnotes, and bibliography, respectively.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

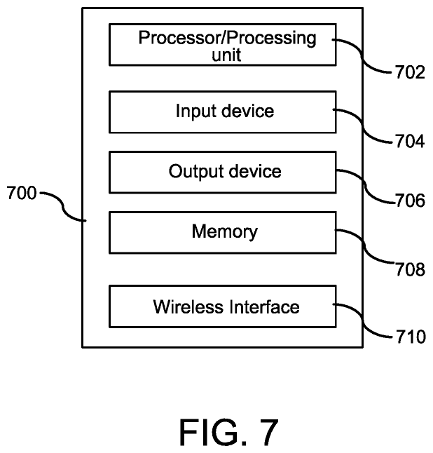

FIG. 7 illustrates an exemplary computing device that is used for installing the software application 304 of the present invention in accordance with the disclosed architecture. It should be noted that the present invention can be used in the form of a plug-in installed in a browser or can be accessed using a website through a browser application. The computing device 700 can be any electronic device, smartphone, smartwatch, and more. The processing unit 702 may include suitable logic, instructions, circuitry, interfaces, and/or codes for executing various operations, such as the operations associated with the user device 700, or the like. The processing unit 702 may be configured to control one or more operations executed by the user device 700 in response to the input received at the user device 700 from the user. The processor 702 executes the computer readable instructions stored in the application 304. Examples of the processing unit 702 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include or otherwise cover any type of the processing unit 702 including known, related art, and/or later developed processing units. The user device 700 can further include one or more computer executable applications configured to be executed by the processing unit 702. The one or more computer executable applications may include suitable logic, instructions, and/or codes for executing various operations. The one or more computer executable applications may be stored in the memory 708. The one or more computer executable applications includes the application 304.

The user device 700 includes input device(s) 704 such as a touch input device, voice input device, etc., for entering data and information. Preferably, the touch interface of the user device 700 is used as the input, and various buttons/tabs shown on the application 304 are pressed or clicked by the user. The display of the user device 700 also acts as the output device 706 for displaying various content (e.g., text, images, videos, icons, and/or symbols, etc.) to the user. The display can include a touch screen, and may receive, for example, a touch, gesture, proximity, or hovering input using an electronic pen or a part of a user's body.

An electronic device 700 has memory 708 used for storing programs (sequences of instructions) or data (e.g., program state information) on a temporary or permanent basis for use in the computer system. Memory 708 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 702, in combination with one or more of memory 708, input device(s) 704, output device(s) 706 is utilized to provide users to execute instructions on the application 304. The connection to a network is provided by wireless interface 710.

The wireless interface 710 enables the user device 700 to communicate with the server and other components of the system 100 over the communication network, according to embodiments of the present disclosure. Examples of the communication interface 710 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “computer implemented citation software application system”, “module system”, and “system” are interchangeable and refer to the computer implemented citation software application system 200 of the present invention. Similarly, as used herein “citation software application”, “software application”, and “application” are interchangeable and refer to the citation software application 304 of the present invention.

Notwithstanding the foregoing, the computer implemented citation software application system 200 of the present invention can be of any suitable configuration as is known in the art without affecting the overall concept of the invention, provided that it accomplishes the above-stated objectives. One of ordinary skill in the art will appreciate that the computer implemented citation software application system 200 as shown in the FIGS. are for illustrative purposes only, and that many other configurations are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for performing computer implemented citations of a document, the method comprising the steps of:
selecting a text by a user;
receiving said selected text and a citation of a document of said selected text;
parsing said document to identify said selected text including said citation;
wherein said selected text having said citation including information selected from a group consisting of a metadata, an author, a page number, and a date;
extracting said citation from said selected text;
associating said citation to said selected text;
creating a reference number associated with said document and said citation;
indexing said reference number; and
storing in a second document said reference number.

2. The method of claim 1 further comprising the steps of:
receiving a request from a user said reference number and said citation; and,
choosing said citation selected from a group consisting of a footnote citation, a bibliography citation, and an in-text citation.

3. The method of claim 2 further comprising the steps of:
retrieving said reference number and said citation; and
applying said citation as said footnote citation, said bibliography citation, or said in-text citation.

4. The method of claim 3, wherein said text is selected from said document including a group consisting of a few words, a few sentences, a few paragraphs, a quote and an idea.

5. The method of claim 4, wherein said document is selected from a group consisting of an HTM document, a Web page, a PDF file, and an image file.

6. The method of claim 5, wherein said citation is a URL.

7. The method of claim 5, wherein said parsing identifies said metadata of said citation.

8. A method for performing computer implemented citations of a document, the method comprising the steps of:
selecting a text by a user;
receiving said selected text and a citation of a document containing said selected text;
parsing said document to identify said selected text including said citation, wherein said selected text having said citation including information selected from a group consisting of a metadata, an author, a page number, and a date;
extracting said citation from said selected text, wherein said citation is formatted as a footnote citation, a bibliography citation, and an in-text citation;
associating said citation to said selected text;
creating a reference number associated with said document and said citation;
indexing said reference number;
storing in a second document said reference number;
receiving a request from a user said reference number and said citation; and
choosing said citation selected from a group consisting of a footnote citation, a bibliography citation, and an in-text citation.

9. The method of claim 8 further comprising the steps of:
retrieving said reference number and said citation; and
applying said citation as said footnote citation, said bibliography citation, or said in-text citation.

10. The method of claim 9, wherein said text is selected from said document including a group consisting of a few words, a few sentences, a few paragraphs, a quote and an idea.

11. The method of claim 10, wherein said document is selected from a group consisting of an HTM document, a Web page, a PDF file, and an image file.

12. The method of claim 11, wherein said citation is a URL.

13. The method of claim 11, wherein said parsing identifies said metadata of said citation.

14. A method for logging and organizing references of a research paper, the method comprising the steps of:
configuring a reference page in a specialized document to receive text from a user;
including consecutive portions to said reference page of a plurality of references of different documents;
creating a plurality of said reference pages; and
providing a document search module for searching a source of said text included in said plurality of references of different documents, wherein said specialized document containing said text of said reference page identified by said search module is converted into Extensible Markup Language (XML) format by a PDF/HTML to XML converter, and further wherein said conversion to said XML format extracts said text and metadata information from said plurality of references of different documents.

15. The method of claim 14 further comprising a step of providing a plurality of user interfaces for said user to index and organize said plurality of references of different documents.

16. The method of claim 15, wherein said conversion to said XML format includes converting formats of Hypertext Markup Language (HTML), Portable Document Format (PDF), and PostScript (PS) format to said XML format.

17. The method of claim 16 further comprising a step of extracting a relevant textual portion with a text extractor module from one of said plurality of references of different documents and wherein said text extractor scans said relevant textual portion, identifies said relevant textual portion, and retrieves said relevant textual portion.

18. The method of claim 17 further comprising a step of retrieving metadata with a metadata extractor from said one of said plurality of references of different documents, wherein said metadata includes information selected from a group consisting of an author, a page number, and a date of said one of said plurality of references.

19. The method of claim 18 further comprising a step of passing said relevant textual portion and said metadata onto a reference creator module to produce an indexed reference for use by said user, wherein said indexed reference created by said creator module contains said relevant textual portion and said metadata, and further wherein said indexed reference is stored in a holding page.

20. The method of claim 19 further comprising a step of selecting said indexed reference with a reference retriever module by said user to retrieve said metadata, wherein said metadata is a citation selected from a group consisting of a footnote citation, a bibliography citation, and an in-text citation, and further wherein said indexed reference is included in a research paper.
